(19) United States
(12) Patent Application Publication
(10) Pub. No.: US 2007/0069572 A1
(43) Pub. Date: Mar. 29, 2007

(54) Wheel Rim with Hollow Flanges for Mounting of a Tire

(75) Inventor: Chao-Ying Chen, Tainan Hsien (TW)

Correspondence Address: WHYTE HIRSCHBOECK DUDEK S C, 555 EAST WELLS STREET, SUITE 1900, MILWAUKEE, WI, 53202, US

(73) Assignee: ALEX GLOBAL TECHNOLOGY, INC., Tainan Hsien (TW)

(21) Appl. No.: 11/460,792

(22) Filed: Jul. 28, 2006

(30) Foreign Application Priority Data
Sep. 26, 2005 (TW) 094133364

(51) Int. Cl. B60B 21/02

(52) U.S. Cl. 301/30

(57) ABSTRACT

A wheel rim is adapted for mounting of a tire thereon, and comprises an annular frame. The annular frame includes two end surfaces abutting against each other, an annular bottom wall, and a pair of annular left and right sidewalls extending respectively, radially, and outwardly from left and right sides of the bottom wall. Two annular flanges extend respectively and axially from radial outer ends of the left and right sidewalls toward each other. Each of the flanges is formed with a first through hole that extends from one of the end surfaces to the other of the end surfaces.

### CROSS-REFERENCE TO RELATED APPLICATION

This application claims priority of Taiwanese Application No. 094133364, filed on Sep. 26, 2005.

### BACKGROUND OF THE INVENTION

1. Field of the Invention

This invention relates to a wheel rim, and more particularly to a wheel rim that is formed with hollow rim flanges.

2. Description of the Related Art

Referring to FIG. 1, a conventional bicycle wheel rim 2 includes an annular frame 21, and two engaging rods 22 each inserted into two end surfaces of the annular frame 21. The annular frame 21 includes an annular bottom wall 211, and two annular sidewalls 212 extending respectively and radially from left and right sides of the bottom wall 211 for mounting of a tire (not shown) thereon. A radial inner end of each of the sidewalls 212 has a through hole 210 formed therethrough and extending along a circumferential direction thereof for insertion of the corresponding engaging rod 22.

Designs of wheel rims focus on structural strength and lightness. Typically, to strengthen the wheel rim 2, the thicknesses of the bottom wall 211 and the sidewalls 212 can be increased during manufacture. However, this results in an increase in the weight of the wheel rim 2.

Radial outer ends of the sidewalls 212 are formed with solid flanges 213. When receiving large axial loads, the solid flanges 213 are apt to bend laterally and flex.

### SUMMARY OF THE INVENTION

An object of this invention is to provide a wheel rim that has a structural strength, which is increased without an increase in the weight of the wheel rim.

Another object of this invention is to provide a wheel rim that includes rim flanges, which do not bent laterally and flex when receiving large axial loads.

According to this invention, a wheel rim is adapted for mounting of a tire thereon, and comprises:

an annular frame including
two end surfaces abutting against each other,
an annular bottom wall having opposite left and right sides,
a pair of annular left and right sidewalls extending respectively, radially, and outwardly from the left and right sides of the bottom wall, and
two annular flanges extending respectively and axially from radial outer ends of the left and right sidewalls toward each other, each of the flanges being formed with a first through hole that extends from one of the end surfaces to the other of the end surfaces and that has two aligned ends formed respectively in the end surfaces.

Since the flanges are hollow, both high structural strength and lightness of the wheel rim are attained, and lateral bending and flexing of the flanges can be prevented.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a fragmentary exploded perspective view of a conventional wheel rim;

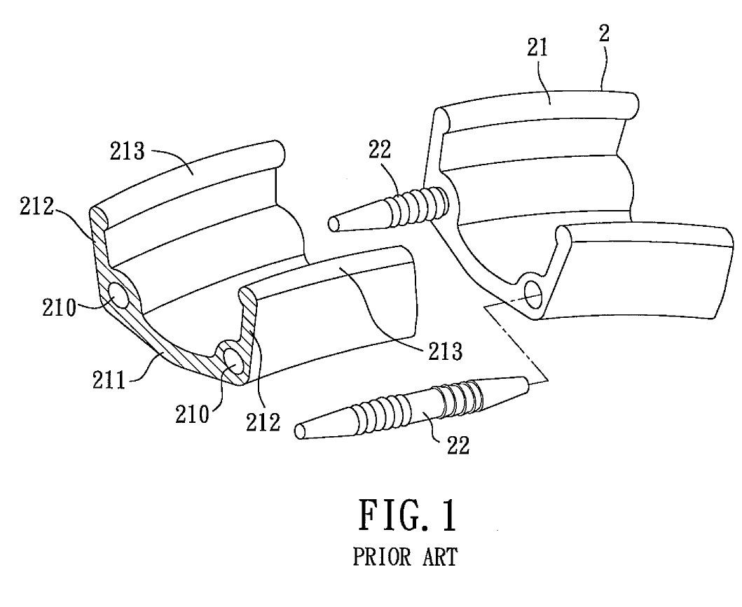

FIG. 2 is a perspective view of the first preferred embodiment of a wheel rim according to this invention, which is partly cut away for illustrating a pair of first and second engaging rods;

FIG. 3 is a fragmentary exploded perspective view of the first preferred embodiment;

FIG. 4 is a fragmentary exploded perspective view of the second preferred embodiment of a wheel rim according to this invention; and

FIG. 5 is a fragmentary sectional view of the second preferred embodiment, illustrating how a tire is mounted on the wheel rim.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

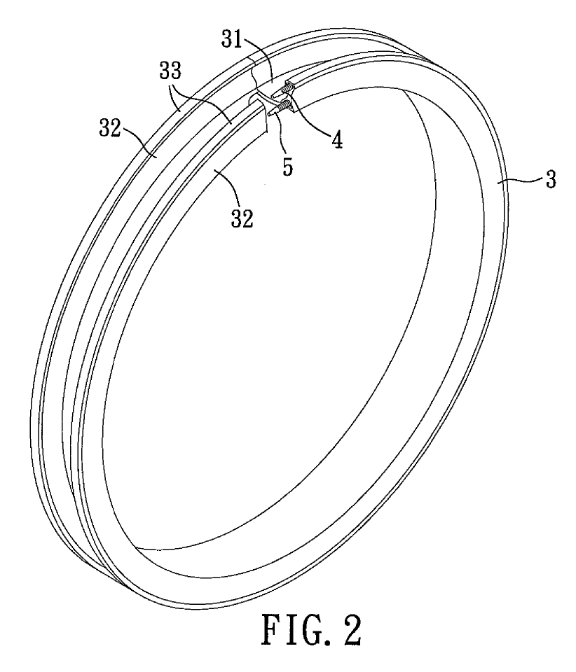

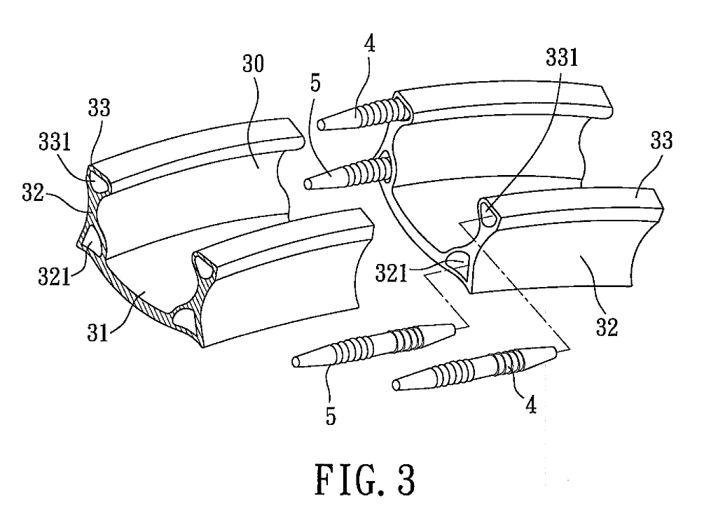

Referring to FIGS. 2 and 3, the first preferred embodiment of a bicycle wheel rim according to this invention is adapted for mounting of a tire (not shown) thereon. The wheel rim includes an annular frame 3 having two end surfaces abutting against each other in a known manner, two first engaging rods 4, and two second engaging rods 5. Each of the first and second engaging rods 4, 5 is inserted into the end surfaces.

The annular frame 3 includes an annular bottom wall 31, a pair of annular left and right sidewalls 32 extending respectively, radially, and outwardly from left and right sides of the bottom wall 31, and two annular flanges 33 extending respectively and axially from radial outer ends of the left and right sidewalls 32 toward each other and spaced apart from each other by a distance smaller than that between the left and right sidewalls 32. The tire is mounted between the flanges 33. In this embodiment, the annular frame 3 is formed from a strip of an aluminum alloy extrusion by pressing. Alternatively, the annular frame 3 may be formed from any other suitable lightweight material or by any other suitable manufacturing process.

Each of the flanges 33 is formed with a first through hole 331 that extends from one of the end surfaces to the other of the end surfaces and that has two aligned ends formed respectively in the end surfaces. Each of the left and right sidewalls 32 has a radial inner end formed with a second through hole 321 that extends from one of the end surfaces to the other of the end surfaces and that has two aligned ends formed respectively in the end surfaces.

The first engaging rods 4 are inserted respectively into the first through holes 331 in the flanges 33. Each of the first engaging rods 4 extends through the ends of the first through hole 331 in the corresponding flange 33. In this embodiment, two opposite end portions of each of the first engaging rods 4 are press-fitted respectively within the ends of the first through hole 331 in the corresponding flange 33. The second engaging rods 5 are inserted respectively into the second through holes 321 in the left and right sidewalls 32. Each of the second engaging rods 5 extends through the ends of the second through holes 321 in a corresponding one of the left and right sidewalls 32. In this embodiment, two opposite end portions of each of the second engaging rods 5 are press-fitted respectively within the ends of the second through hole 321 in the corresponding one of the left and right sidewalls 32. As such, the end surfaces of the annular frame 3 are interconnected firmly. The first engaging rods 4 may be omitted from the structure of the wheel rim. Further, the end surfaces of the annular frame 3 may be interconnected in any other suitable manner.

Since the flanges 33 are hollow, both high structural strength and lightness of the wheel rim are attained, and lateral bending and flexing of the flanges 33 can be prevented.

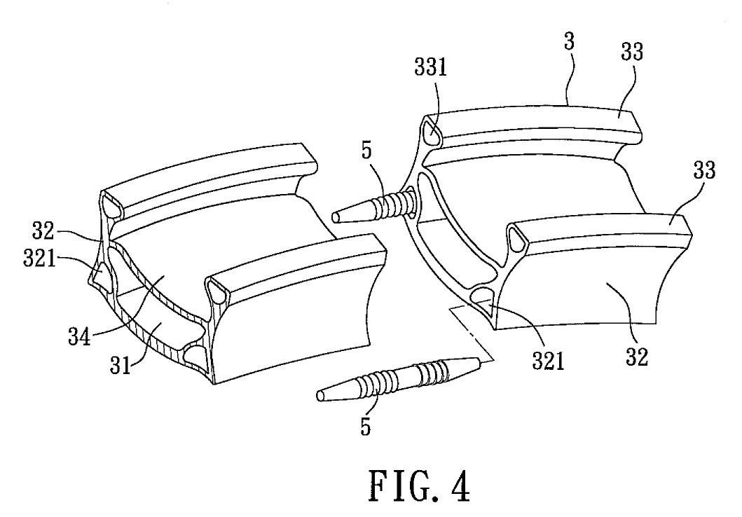

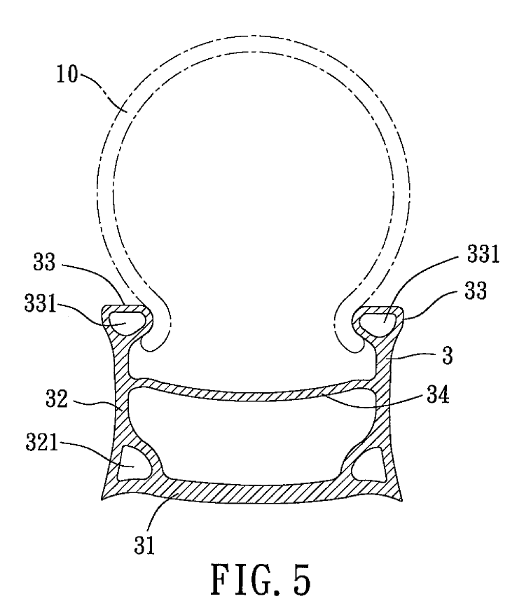

FIGS. 4 and 5 show the second preferred embodiment of a wheel rim according to this invention, which is a modification of the first preferred embodiment. Unlike the first preferred embodiment, the first engaging rods 4 (see FIG. 3) are omitted from the structure of the wheel rim, and the annular frame 3 further includes an annular reinforcing wall 34 disposed between and formed integrally with the left and right sidewalls 32 and disposed around and spaced apart from the bottom wall 31.

The tire is inserted between the flanges 33, as shown in FIG. 5.

In sum, due to the hollow structure of the flanges 33, the wheel rim can be strengthened without an increase in the thicknesses of the bottom wall 31 and the left and right sidewalls 32, that is, without an increase in the weight of the wheel rim. Therefore, the objects of this invention are achieved.

With this invention thus explained, it is apparent that numerous modifications and variations can be made without departing from the scope and spirit of this invention. It is therefore intended that this invention be limited only as indicated by the appended claims.

I claim:

1. A wheel rim adapted for mounting of a tire thereon, said wheel rim comprising:
an annular frame including
two end surfaces abutting against each other,
an annular bottom wall having opposite left and right sides,
a pair of annular left and right sidewalls extending respectively, radially, and outwardly from said left and right sides of said bottom wall, and
two annular flanges extending respectively and axially from radial outer ends of said left and right sidewalls toward each other, each of said flanges being formed with a first through hole that extends from one of said end surfaces to the other of said end surfaces and that has two aligned ends formed respectively in said end surfaces.

2. The wheel rim as claimed in claim 1, further comprising two first engaging rods inserted respectively into said first through holes in said flanges, each of said first engaging rods extending through said ends of said first through hole in a corresponding one of said flanges.

3. The wheel rim as claimed in Claim 1, wherein each of said left and right sidewalls has a radial inner end formed with a second through hole that extends from one of said end surfaces to the other of said end surfaces and that has two aligned ends formed respectively in said end surfaces.

4. The wheel rim as claimed in claim 3, further comprising two second engaging rods inserted respectively into said second through holes in said left and right sidewalls, each of said second engaging rods extending through said ends of said second through hole in a corresponding one of said left and right sidewalls.

5. The wheel rim as claimed in claim 1, wherein said annular frame further includes an annular reinforcing wall disposed between and formed integrally with said left and right sidewalls and disposed around and spaced apart from said bottom wall.
